(19) United States
(12) Patent Application Publication
(10) Pub. No.: US 2010/0300617 A1
(43) Pub. Date: Dec. 2, 2010

(54) SHAPED BODY COMPRISING A SOFT FOAM LAYER AND A LAYER OF A FLOWABLE MATERIAL APPLIED THERETO

(76) Inventor: Zeki Incel, Berlin (DE)

Correspondence Address: DAVID A. GUERRA;INTERNATIONAL PATENT GROUP, LLC, Suite 700, 1816 Crowchild Trail N.W., CALGARY, AB, T2M 3Y7, CA

(21) Appl. No.: 12/678,211

(22) PCT Filed: Sep. 14, 2007
(86) PCT No.: PCT/IB07/02679

§ 371 Date: Aug. 17, 2010

(30) Foreign Application Priority Data
Sep. 14, 2007 (IB) PCT/IB2007/002679

(51) Int. Cl. B32B 37/02

(52) U.S. Cl. 156/279

(57) ABSTRACT

A shaped body, in particular mineral plates and/or mats, for protecting surfaces and/or designing surfaces for internal and external applications, for example as a floor covering or wall covering, is characterized in that a reticulated and open-cell soft foam layer is applied over the surface of a carrier layer and a flowable, dry material layer is applied over the soft foam layer, wherein the material layer meshes into the soft foam layer and is fixedly connected thereto.

The present invention relates to a shaped body, in particular mineral plates and/or mats, for protecting surfaces and/or designing surfaces for internal and external applications.

Such mats and/or plates are presently produced in such a manner that defined materials are moistened and brought to the required thicknesses by pressing or are placed with binders in a flowing consistency in moulds and then cured in these or are produced continuously in an extrusion process. These production modes have the disadvantage that they are necessarily form-dependent, associated with mixing processes and are dependent on temporally predefined sequences which cannot be interrupted, for example, with regard to temperatures and pot lives.

The object of the present invention consists in:
a) making the production process with dry and liquid components become independent of adhering to specific sequence times;
b) being able to interrupt the production process at any time without any disadvantage, for example, in order to allow alternative continuations of the production, in particular to exchange individual components or add others;
c) providing the plates or mats produced with the capability that the elements are absorbent and allow complete impregnation with another binder so that the plates or mats adjacent to one another form a uniform surface due to the uniform impregnation and hardening in order to be able to ensure a uniform join between mats or plates under the carrier layer located thereunder with the stresses between the plates and mats being compensated;
d) applying the mats or plates in the moist state before binding to uneven, for example, corrugated carriers so that after binding, they have taken on the form of the substrate.

The object is achieved according to the invention by the characterising features of claim 1.

A reticulated, open-cell soft foam, in particular a PU soft foam, cut to the thickness of the mats or plates (FIG. 1, soft foam layer 1) and specifically in thicknesses of in particular 3 mm and a pore size of in particular 1.0 to 1.5 mm is fixedly (FIG. 1 carrier layer 3) or removably (FIG. 1, detachable carrier layer 2) plane-fixed to a carrier material.

The carrier layer 2, 3 can consist of plastic films, paper, hard foam plates, wood or metal plates or the like.

Applied to the soft foam layer 1 is a flowable dry material (FIG. 1, dry material layer 6), in particular sand having grain sizes of in particular 0.1 to 0.5 mm, consisting of quartzites, calcites, granites, metal granules or the like which can be mixed dry with cement, gypsum or powdery synthetic silicate binders, powdery synthetic thermosetting or thermoplastic binders, so that all the cells of the soft foam layer 1 are filled.

The soft foam layer 1 filled with the dry material layer 6 is
a) sprayed or nebulised with water and/or modified water;
b) sprayed or perfused with low-viscosity, liquid synthetic or natural resins (FIG. 1; layer 7);
   wherein the synthetic resins in this case can consist of: epoxy resins, acrylic resins, PU resins, polyester resins, melamine resins or the like;
c) the liquid substances specified under b) can be solidified in the dry powdery thermoplastic state by heat and pressure; and
d) are sprayed or perfused with liquid water glass.

If the material (layer 7) located on the surface exceeds the thickness of in particular 3 mm, it is removed by stripping, and covered and joined with fabric, paper (FIG. 1, item 4), plastic (FIG. 1, reinforcing layer 5) or other materials. The covering can either be used temporarily to protect the layer 7 during transport before being removed subsequently or it remains joined to the layer.

The mats or plates thus produced can be produced with an intermediate layer of different reinforcing layers 5, also in a plurality of layers one above the other in order to effect a greater load-bearing capacity and stability. In this case, the stacked plates or mats can also consist of different types of materials in order to be able to satisfy different requirement profiles.

The mats or plates thus produced are applied in the state not yet bound (FIG. 2, soft foam layer 1) to corrugated, cylindrical or irregularly shaped carriers (FIG. 2, carrier layer 3) and take on the shape of the carrier after binding.

### REFERENCE LIST

1 Soft foam layer
2 Detachable carrier layer
3 Carrier layer
5 Reinforcing layer
6 Dry material layer
7 Layer

1. A method for producing shaped bodies, in particular mineral plates or mats, for protecting surfaces and/or designing surfaces for internal and external applications, characterised in that a reticulated soft foam in thicknesses of in particular 3 mm, having pore sizes of in particular 1.0 to 1.5 mm, is plane-fixed to a carrier material;
that a flowable dry material having grain sizes of in particular 0.1 to 0.5 mm is applied to the soft foam in such a manner that all the cells of the soft foam are thereby filled;
that onto the soft foam thus treated and filled with flowable material,
either water is sprayed or nebulised thereon,
or low-viscosity liquid synthetic or natural resins are cast or sprayed thereon
or liquid water glass is sprayed or cast thereon and
that too much applied material is removed by stripping.

2. The method according to claim 1, characterised in that the flowable material consists of sands and/or metal granules.

3. The method according to claim 2, characterised in that the sands are selected from a group consisting of quartzites, calcites, granites.

4. The method according to claim 1, characterised in that a covering of fabric, paper, plastic or the like is then applied to the surface of the soft foam filled with treated material.

5. The method according to any one of claims 1 to 4, characterised in that the low-viscosity liquid synthetic resins are selected from a group consisting of epoxy resins, acrylic resins, PUR resins, polyester resins, melamine resins.

6. The method according to any one of claims 1 to 5, characterised in that a hard foam, wood or metal plate is used as solid carrier material.

7. The method according to any one of claims 1 to 5, characterised in that a plastic film or paper is used as flexible carrier material.

8. The method according to any one of claims 1 to 7, characterised in that before filling, the flowable material to be poured into the soft foam is mixed dry with a material from the group consisting of cement, gypsum, powdery synthetic silicate binders, powdery synthetic thermosetting or thermoplastic binders.

9. A method for producing shaped bodies, in particular mineral plates or mats, for protecting surfaces and/or designing surfaces for internal and external applications, characterised in that a reticulated soft foam in thicknesses of in particular 3 mm, having pore sizes of in particular 1.0 to 1.5 mm, is plane-fixed to a carrier material;
that a flowable dry material having grain sizes of in particular 0.1 to 0.5 mm is applied to the soft foam in such a manner that all the cells of the soft foam are thereby filled;
that before filling, the flowable material to be poured into the soft foam is mixed dry with a material from the group consisting of cement, gypsum, powdery synthetic silicate binders, powdery synthetic thermosetting or thermoplastic binders; and
that too much applied material is removed by stripping.

10. The method according to claim 9, characterised in that the powdery, synthetic, thermosetting or thermoplastic binders mixed with the flowable powdery material and poured into the soft foam are fused by means of heat and pressure.

11. The method according to claim 10, characterised in that the flowable material consists of sands and/or metal granules.

12. The method according to claim 11, characterised in that the sands are selected from a group consisting of quartzites, calcites, granites.

13. The method according to any one of claims 9 to 12, characterised in that a covering of fabric, paper, plastic or the like is then applied permanently or detachably to the surface of the soft foam filled with treated material.

14. The method according to any one of claims 9 to 13, characterised in that a hard foam, wood or metal plate is used as solid carrier material.

15. The method according to any one of claims 9 to 13, characterised in that a plastic film or paper is used as flexible carrier material.

16. The method according to any one of claims 9 to 15, characterised in that onto the soft foam thus treated and filled with flowable material,
either water is sprayed or nebulised thereon,
or low-viscosity liquid synthetic or natural resins are cast or sprayed thereon
or liquid water glass is sprayed or cast thereon.
